(19) United States
(12) Patent Application Publication
(10) Pub. No.: US 2015/0376550 A1
(43) Pub. Date: Dec. 31, 2015

(54) LAUNDRY DETERGENT COMPOSITION

(71) Applicant: The Procter & Gamble Company, Cincinnati, OH (US)

(72) Inventors: Ryohei OHTANI, NISHINOMIYA (JP); Misa AZUMA, YAO (JP)

(21) Appl. No.: 14/753,040

(22) Filed: Jun. 29, 2015

Related U.S. Application Data
(60) Provisional application No. 62/018,680, filed on Jun. 30, 2014.

(51) Int. Cl. C11D 3/24; C11D 1/22; C11D 1/12; C11D 3/48; C11D 1/83; C11D 17/04; C11D 3/50; C11D 3/37; C11D 1/66

(52) U.S. Cl. CPC C11D 3/24; C11D 3/3703; C11D 3/3773; C11D 1/22; C11D 1/12; C11D 1/66; C11D 1/83; C11D 17/043; C11D 3/50; C11D 3/48

(57) ABSTRACT

A laundry detergent composition, comprising: by weight of the composition, from 0.001% to 3% of a nonionic anti-microbial agent, and from 0.05% to 5% of a perfume microcapsule that comprises a shell and a core of perfume oil encapsulated within the shell. The laundry detergent composition provides treated fabrics with improved freshness, particularly with both long-lasting freshness and effective malodor control against a broad spectrum of bacteria.

### FIELD OF THE INVENTION

The present invention relates to a laundry detergent composition and a water-soluble pouch comprising the laundry detergent composition.

### BACKGROUND OF THE INVENTION

Laundry detergents have evolved to address user needs for improved freshness to treated fabrics, in addition to their original intended functions (namely, the cleaning function). Such improved freshness is typically characterized by long-lasting freshness of the fabric treated by the detergent. In the art, one approach to providing the long-lasting freshness is to encapsulate perfume oils in a friable microcapsule, namely, perfume microcapsules (PMCs). PMCs comprise a shell and a core of perfume oil encapsulated within the shell. The perfume oil is substantially not released from the PMCs until the shell is ruptured from a mechanical stress (e.g., friction). The perfume oil is therefore protected from volatilization to the surrounding air space for a prolonged duration of time. When incorporated into a laundry detergent composition, PMCs deposit onto fabrics during a wash or rinse cycle. Such, PMCs, when deposited on fabrics, exhibit a burst of perfume upon rupturing.

However, with regard to malodor control (which is another aspect of freshness improvement), the use of PMCs alone is not ideal yet. Specifically, although PMCs provide a burst of perfume upon rupturing, the perfume released from PMCs is typically not sufficient to mask the malodors generated during usage or wear of the fabric (at least for an extended period of time). These malodors are caused by bacteria growth, e.g., body malodors that impregnate clothing, or malodors of a used kitchen towel. Both Gram positive and Gram negative bacteria can contribute to these malodors. Despite that many anti-microbial agents are known in the art to be incorporated into laundry detergents to kill bacteria or prevent bacteria growth, many of these agents fail to work effectively against both Gram positive and Gram negative bacteria. Thus a significant source of malodors is left untreated.

Thus, there is a need for a laundry detergent composition that provides treated fabrics with improved freshness, particularly with both long-lasting freshness and effective malodor control against a broad spectrum of bacteria (namely, both Gram positive and Gram negative bacteria).

It is an advantage of the present invention to provide a stable, anti-microbial liquid laundry detergent composition.

It is another advantage of the present invention to provide a laundry detergent composition that minimizes the amount of anti-microbial agents, both amount and number of chemicals, to achieve a broad spectrum of bacterial control.

### SUMMARY OF THE INVENTION

The present invention is directed to a laundry detergent composition, comprising:

a) from 0.001% to 3%, by weight of the composition, of a nonionic anti-microbial agent; and

b) from 0.05% to 5%, by weight of the composition, of a perfume microcapsule (PMC), wherein the PMC comprises a shell and a core of perfume oil encapsulated within said shell.

In another aspect, the present invention is directed to a pouch comprising a water-soluble film and the aforementioned laundry detergent composition within the water-soluble film.

### DETAILED DESCRIPTION OF THE INVENTION

In the present invention, it has been surprisingly found that, by selecting a particular type of anti-microbial agent and a PMC, each at a certain level, the laundry detergent composition of the present invention demonstrates improved freshness to a treated fabric and malodor control against a broad spectrum of bacteria. Without wishing to be bound by theory, it is believed that due to its anti-microbial property, particularly its anti-microbial property against both Gram positive and Gram negative bacteria, the nonionic anti-microbial agent herein prevents bacteria growth and therefore reduces the spectrum of malodors of a treated fabric significantly after laundering. This broader malodor reduction effect by the nonionic anti-microbial agent, in combination with the long-lasting freshness enabled by the PMC, delivers the improved freshness benefit to the treated fabric.

### DEFINITIONS

As used herein, the term “laundry detergent composition” means a composition relating to cleaning fabrics. Preferably, the laundry detergent composition is a liquid laundry detergent composition. The term “liquid laundry detergent composition” herein refers to laundry detergent compositions that are in a form selected from the group consisting of pourable liquid, gel, cream, and combinations thereof. The liquid laundry detergent composition may be either aqueous or non-aqueous, and may be anisotropic, isotropic, or combinations thereof.

As used herein, the term “anti-microbial agent” refers to a chemical compound of which the principle intended function is to kill bacteria or to prevent their growth or reproduction. Anti-microbial agents include cationic anti-microbial agents (e.g., certain ammonium chlorides), nonionic anti-microbial agents, etc. Diphenyl ether compounds that are used in the present invention are nonionic anti-microbial agents.

As used herein, the term “pouch” refers to a type of detergent product comprising a water-soluble film and a detergent composition contained in the water-soluble film. The term “compartment” herein refers to a portion of the pouch in which a detergent composition is enveloped by the water-soluble film.

As used herein, the term “perfume oil” refers to oils comprising one or more perfume raw materials (PRMs) and optional solvents. The perfume oil can be either neat perfume oil or confined perfume oil (that is encapsulated in a PMC). The neat perfume oil herein refers to free, volatile perfume oils, in which the PRMs are free to become volatized and available for olfactory detection by a user. The term “perfume” herein is a general term that could refer to PRM, perfume delivery system, perfume oil, or a pleasant scent achieved thereby. The terms “scent” and “odor” are synonymous.

As used herein, the term “washing solution” refers to the typical amount of aqueous solution used for one cycle of laundry washing, preferably from 1 L to 50 L, alternatively from 1 L to 20 L for hand washing and from 20 L to 50 L for machine washing.

As used herein, the term “alkyl” means a hydrocarbyl moiety which is branched or unbranched, substituted or unsubstituted. Included in the term “alkyl” is the alkyl portion of acyl groups.

As used herein, when a composition is “substantially free” of a specific ingredient, it is meant that the composition comprises less than a trace amount, alternatively less than 0.1%, alternatively less than 0.01%, alternatively less than 0.001%, by weight of the composition, of the specific ingredient.

As used herein, the articles including “a” and “an” when used in a claim, are understood to mean one or more of what is claimed or described.

As used herein, the terms “comprise”, “comprises”, “comprising”, “include”, “includes”, “including”, “contain”, “contains”, and “containing” are meant to be non-limiting, i.e., other steps and other ingredients which do not affect the end of result can be added. The above terms encompass the terms “consisting of” and “consisting essentially of”.

### Laundry Detergent Composition

The laundry detergent composition of the present invention comprises: by weight of the composition, from 0.001% to 3% of a nonionic anti-microbial agent, and from 0.05% to 5% of a PMC, wherein the PMC comprises a shell and a core of perfume oil encapsulated within the shell. Preferably in the laundry detergent composition, the nonionic anti-microbial agent is present from 0.01% to 1%, more preferably from 0.03% to 0.5%, by weight of the composition. Generally, the nonionic anti-microbial agent herein is effective against both Gram positive and Gram negative bacteria and therefore can be incorporated at a relatively low level, whilst delivering a desirable malodor control effect. The PMC is preferably present from 0.1% to 4%, more preferably from 0.15% to 2%, by weight of the composition.

In a washing solution, the laundry detergent composition is preferably capable of delivering the anti-microbial agent at a level from 0.01 ppm to 5 ppm, more preferably from 0.05 ppm to 3 ppm, more preferably from 0.1 ppm to 1 ppm.

Preferably, the laundry detergent composition herein is an anti-microbial laundry detergent composition. In one embodiment, the composition provides anti-microbial benefits against both Gram positive bacteria (e.g., Staphylococcus aureus) and Gram negative bacteria (e.g., Klebsiella pneumoniae). The composition preferably provides residual anti-microbial benefits to the fabrics treated by the composition, i.e., the nonionic anti-microbial agent therein deposits onto the fabrics during a wash cycle and subsequently the deposited (i.e., residual) antimicrobial-agent prevents bacteria growth onto the fabrics during drying or storage or wear. In one embodiment, the laundry detergent composition provides a Bacteriostatic Activity Value of at least a log 2.2 reduction against both Gram positive bacteria and Gram negative bacteria, to treated fabrics versus non-treated fabrics. Preferably, the composition provides at least a log 2.2 reduction against Staphylococcus aureus and/or Klebsiella pneumoniae after a 10 minutes contact time in a 2069 ppm aqueous solution as determined by the JISL 1902 method (that is described below). More preferably, the composition provides at least a log 2.2 reduction against Staphylococcus aureus. It is worth noting that Staphylococcus aureus is frequently found on human skin and therefore fabrics (particularly wearing fabrics) are in particular need of anti-microbial effects against Staphylococcus aureus.

The laundry detergent composition herein may be acidic or alkali or pH neutral, depending on the ingredients incorporated in the composition. The pH range of the laundry detergent composition is preferably from 6 to 12, more preferably from 7 to 10, even more preferably from 7 to 9.

The composition herein can have any suitable viscosity depending on factors such as formulated ingredients and purpose of the composition. In one embodiment, the composition has a high shear viscosity value, at a shear rate of 20/sec and a temperature of 21° C., of 100 to 3,000 cP, alternatively 300 to 2,000 cP, alternatively 500 to 1,000 cP, and a low shear viscosity value, at a shear rate of 1/sec and a temperature of 21° C., of 500 to 100,000 cP, alternatively 1000 to 10,000 cP, alternatively 1,300 to 5,000 cP.

Nonionic Anti-Microbial Agent

The anti-microbial agent of the present invention is nonionic. In the present invention, it has been found that due to its nonionic property, the anti-microbial agent herein allows for a stable anti-microbial laundry detergent composition, particularly in a context of liquid composition. By contrast, traditional cationic anti-microbial agents are typically not compatible with anionic surfactants present in laundry detergent compositions.

The anti-microbial agent is preferably a diphenyl ether, more preferably a hydroxyl diphenyl ether. The nonionic anti-microbial agent herein can be either halogenated or non-halogenated, but preferably is halogenated. Diphenyl ethers suitable for use herein are described from Col. 1, line 54 to Col. 5, line 12 in U.S. Pat. No. 7,041,631B, which is incorporated by reference.

In one embodiment, the nonionic anti-microbial agent is a hydroxyl diphenyl ether of formula (I):

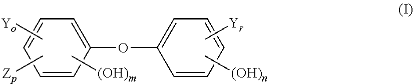

each Y is independently selected from chlorine, bromine, or fluorine, preferably is chlorine or bromine, more preferably is chlorine,

each Z is independently selected from SO₂H, NO₂, or C₁-C₄ alkyl,

r is 0, 1, 2, or 3, preferably is 1 or 2,

o is 0, 1, 2, or 3, preferably is 0, 1 or 2,

p is 0, 1, or 2, preferably is 0,

m is 1 or 2, preferably is 1, and

n is 0 or 1, preferably is 0.

In the above definition for formula (I), 0 means nil. For example, when p is 0, then there is no Z in formula (I). Each Y or Z could be the same or different. In one embodiment, o is 1, r is 2, and Y is chlorine or bromine. This embodiment could be: one chlorine atom bonds to a benzene ring while the bromine atom and the other chlorine atom bond to the other benzene ring; or the bromine atom bonds to a benzene ring while the two chlorine atoms bond to the other benzene ring.

Preferably, the nonionic anti-microbial agent herein is selected from the group consisting of 4-4′-dichloro-2-hydroxy diphenyl ether (“Diclosan”), 2,4,4′-trichloro-2′-hydroxy diphenyl ether (“Triclosan”), and a combination thereof. Most preferably, the anti-microbial agent is 4-4′-dichloro-2-hydroxy diphenyl ether, commercially available from BASF, under the trademark name Tinosan®HP100.

In addition to the diphenyl ether, other anti-microbial agents may also be present, provided that these are not present at a level which causes instability in the formulation. Among such useful further antimicrobial agents are chelating agents, which are particularly useful in reducing the resistance of Gram negative microbes in hard water. Acid biocides may also be present.

Perfume Microcapsule (PMC)

The PMC of the present invention comprises a shell and a core of perfume oil encapsulated within the shell. PMCs are described in the following references: US 2003/215417 A1; US 2003/216488 A1; US 2003/158344 A1; US 2003/165692 A1; US 2004/071742 A1; US 2004/071746 A1; US 2004/072719 A1; US 2004/072720 A1; EP 1,393,706 A1; US 2003/203829 A1; US 2003/195133 A1; US 2004/087477 A1; US 2004/0106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; U.S. Pat. No. RE32,713; U.S. Pat. No. 4,234,627.

The encapsulated perfume oil can comprise a variety of PRMs depending on the nature of the product. For example, when the product is a liquid laundry detergent, the perfume oil may comprise one or more perfume raw materials that provide improved perfume performance under high soil conditions and in cold water. In one embodiment, the perfume oil comprises an ingredient selected from the group consisting of allo-ocimene, allyl caproate, allyl heptoate, amyl propionate, anethol, anisic aldehyde, anisole, benzaldehyde, benzyl acetate, benzyl acetone, benzyl alcohol, benzyl butyrate, benzyl formate, benzyl iso valerate, benzyl propionate, beta gamma hexenol, camphene, camphor, carvacrol, laevo-carveol, d-carvone, laevo-carvone, cinnamyl formate, citral (neral), citronellol, citronellyl acetate, citronellyl isobutyrate, citronellyl nitrile, citronellyl propionate, cuminic alcohol, cuminic aldehyde, Cyclal C, cyclohexyl ethyl acetate, decyl aldehyde, dihydro myrcenol, dimethyl benzyl carbinol, dimethyl benzyl carbinyl acetate, dimethyl octanol, diphenyl oxide, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, fenchyl alcohol, flor acetate (tricyclo decenyl acetate), frutene (tricyclo decenyl propionate), gamma methyl ionone, gamma-n-methyl ionone, gamma-nonalactone, geraniol, geranyl acetate, geranyl formate, geranyl isobutyrate, geranyl nitrile, hexenol, hexenyl acetate, cis-3-hexenyl acetate, hexenyl isobutyrate, cis-3-hexenyl tiglate, hexyl acetate, hexyl formate, hexyl neopentanoate, hexyl tiglate, hydratropic alcohol, hydroxycitronellal, indole, isoamyl alcohol, alpha-ionone, beta-ionone, gamma-ionone, alpha-irone, isobornyl acetate, isobutyl benzoate, isobutyl quinoline, isomenthol, isomenthone, isononyl acetate, isononyl alcohol, para-isopropyl phenylacetaldehyde, isopulegol, isopulegyl acetate, isoquinoline, cis-jasmone, lauric aldehyde (dodecanal), Ligustral, d-limonene, linalool, linalool oxide, linalyl acetate, linalyl formate, menthone, menthyl acetate, methyl acetophenone, methyl amyl ketone, methyl anthranilate, methyl benzoate, methyl benzyl acetate, methyl chavicol, methyl eugenol, methyl heptenone, methyl heptine carbonate, methyl heptyl ketone, methyl hexyl ketone, alpha-iso “gamma” methyl ionone, methyl nonyl acetaldehyde, methyl octyl acetaldehyde, methyl phenyl carbinyl acetate, methyl salicylate, myrcene, neral, nerol, neryl acetate, nonyl acetate, nonyl aldehyde, octalactone, octyl alcohol (octanol-2), octyl aldehyde, orange terpenes (d-limonene), para-cresol, para-cresyl methyl ether, para-cymene, para-methyl acetophenone, phenoxy ethanol, phenyl acetaldehyde, phenyl ethyl acetate, phenyl ethyl alcohol, phenyl ethyl dimethyl carbinol, alpha-pinene, beta-pinene, prenyl acetate, propyl butyrate, pulegone, rose oxide, safrole, alpha-terpinene, gamma-terpinene, 4-terpinenol, alpha-terpineol, terpinolene, terpinyl acetate, tetrahydro linalool, tetrahydro myrcenol, tonalid, undecenal, veratrol, verdox, vertenex, viridine, and a combination thereof.

The shell of the PMC herein preferably comprises a material selected from the group consisting of aminoplast, polyacrylate, polyethylene, polyamide, polystyrene, polyisoprenes, polycarbonates, polyester, polyolefin, polysaccharide (e.g., alginate or chitosan), gelatin, shellac, epoxy resin, vinyl polymer, water insoluble inorganic, silicone, and a combination thereof. Preferably, the shell comprises a material selected from the group consisting of aminoplast, polyacrylate, and a combination thereof.

Preferably, the shell of the PMC comprises an aminoplast. A method for forming such shells includes polycondensation. Aminoplast resins are the reaction products of one or more amines with one or more aldehydes, typically formaldehyde. Non-limiting examples of suitable amines include urea, thiourea, melamine and its derivates, benzoguanamine and acetoguanamine and combinations of amines. Suitable cross-linking agents (e.g., toluene diisocyanate, divinyl benzene, butanediol diacrylate etc.) may also be used and secondary wall polymers may also be used as appropriate, e.g. anhydrides and their derivatives, particularly polymers and co-polymers of maleic anhydride as disclosed in WO 02/074430. In one embodiment, the shell comprises a material selected from the group consisting of a urea formaldehyde, a melamine formaldehyde, and a combination thereof, preferably comprises a melamine formaldehyde (cross-linked or not). In one preferred embodiment, the core comprises a perfume oil and the shell comprises a melamine formaldehyde. Alternatively, the core comprises a perfume oil and the shell comprises a melamine formaldehyde and poly(acrylic acid) and poly(acrylic acid-co-butyl acrylate). The PMC of the present invention should be friable in nature. Friability refers to the propensity of the PMC to rupture or break open when subjected to direct external pressures or shear forces or heat. In one embodiment, the perfume oil within the PMCs of the present invention surprisingly maximizes the effect of the perfume bursting by providing a perfume that “blooms” upon rupturing.

In one preferred embodiment, the PMC herein is coated with a coating, preferably a cationically charged coating. Preferably, the shell of the PMC comprises an outer surface, and a coating coats the outer surface. Typically, the shell is a solid material with well defined boundaries, while the coating that adheres to the shell may not have a clear boundary, particularly in an execution of polymer-coated PMC that is described below. The term “cationically charged” herein means that the coating per se is cationic (e.g., by containing a cationic polymer or a cationic ingredient) and does not necessarily mean that the shell is cationic too. Instead, many known PMCs have anionic shells, e.g., melamine formaldehyde, and these PMCs having anionic shells can be coated with a cationic coating. Preferably the coating comprises an efficiency polymer. The term “polymer” herein can be either homopolymers polymerized by one type of monomer or copolymers polymerized by two or more different monomers. The efficiency polymer herein can be either cationic or neutral or anionic, but preferably is cationic. In the execution that the efficiency polymer is anionic or neutral, the coating comprises other ingredients that render its cationic charge. In the execution that the efficiency polymer is cationic, the polymer may comprise monomers that are neutral or anionic, as long as the overall charge of the polymer is cationic. Such a polymer-coated PMC and the manufacturing process thereof are described in U.S. Patent Application No. 2011/0111999A.

In one preferred embodiment, the efficiency polymer is of formula (II),

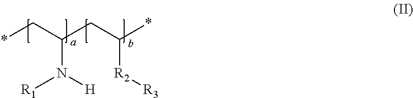

wherein:
a) a and b each independently range from 50 to 100,000;
b) each R¹ is independently selected from H, CH₃, (C═O)H, alkylene, alkylene with unsaturated C—C bonds, CH₂—CROH, (C═O)—NH—R, (C═O)—(CH₂)ₙ—OH, (C═O)—R, (CH₂)ₙ-E, —(CH₂—CH(C═O))ₙ—XR, —(CH₂)ₙ—COOH, —(CH₂)ₙ—NH₂, or —CH₂)ₙ—(C═O)NH₂, the index n ranges from 0 to 24, E is an electrophilic group, R is a saturated or unsaturated alkane, dialkylsiloxy, dialkyloxy, aryl, or alkylated aryl, preferably further containing a moiety selected from the group consisting of cyano, OH, COOH, NH₂, NHR, sulfonate, sulphate, —NH₂, quaternized amine, thiol, aldehyde, alkoxy, pyrrolidone, pyridine, imidazol, imidazolinium halide, guanidine, phosphate, monosaccharide, oligo, polysaccharide, and a combination thereof;
c) R² or R³ is absent or present:
   (i) when R³ is present each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and each R³ is independently selected from the same group as R¹;
   (ii) when R³ is absent each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and
   (iii) when R² is absent, each R³ is independently selected the same group as R¹; and
      wherein the efficiency polymer has an average molecular mass from about 1,000 Da to about 50,000,000 Da; a hydrolysis degree of from about 5% to about 95%; and/or a charge density from about 1 meq/g to about 23 meq/g.

In one embodiment, the efficiency polymer has:

a) an average molecular mass from 1,000 Da to 50,000,000 Da, alternatively from 5,000 Da to 25,000,000 Da, alternatively from 10,000 Da to Ser. No. 10/000,000 Da, alternatively from 340,000 Da to 1,500,000 Da;

b) a hydrolysis degree of from 5% to 95%, alternatively from 7% to 60%, alternatively from 10% to 40%; and/or

c) a charge density from 1 meq/g to 23 meq/g, from 1.2 meq/g to 16 meq/g, from 2 meq/g to about 10 meq/g, or even from 1 meq/g to about 4 meq/g.

In one embodiment, the efficiency polymer is selected from the group consisting of polyvinyl amine, polyvinyl formamide, polyallyl amine, and copolymers thereof. In one preferred embodiment, the efficiency polymer is polyvinyl formamide, commercially available from BASF AG of Ludwigshafen, Germany, under the name of Lupamin® 9030. In an alternative embodiment, the efficiency polymer comprises a polyvinylamide-polyvinylamine copolymer.

Suitable efficiency polymers such as polyvinylamide-polyvinylamine copolymers can be produced by hydrolization of the polyvinylformamide starting polymer. Suitable efficiency polymers can also be formed by copolymerisation of vinylformamide with arcylamide, acrylic acid, acrylonitrile, ethylene, sodium acrylate, methyl acrylate, maleic anhydride, vinyl acetate, n-vinylpyrrolidine. Suitable efficiency polymers or oligomers can also be formed by cationic polymerisation of vinylformamide with protonic acids, such as methylsulfonic acid, and or Lewis acids, such as boron trifluoride.

Particle size and average diameter of the PMCs can vary from 1 micrometer to 100 micrometers, alternatively from 5 micrometers to 80 microns, alternatively from 10 micrometers to 75 micrometers, and alternatively between 15 micrometers to 50 micrometers. The particle size distribution can be narrow, broad, or multimodal. Multimodal distributions may be composed of different types of capsule chemistries.

In one embodiment, the PMC utilized herein generally has an average shell thickness ranging from 0.1 micron to 30 microns, alternatively from 1 micron to 10 microns. In the execution of coated PMC, the PMC herein has a coating to shell ratio in terms of thickness of from 1:200 to about 1:2, alternatively from 1:100 to 1:4, alternatively from 1:80 to about 1:10, respectively.

The PMC can be combined with the composition at any time during the preparation of the laundry detergent composition. The PMC can be added to the composition or vice versa. For example, the PMC may be post dosed to a pre-made composition or may be combined with other ingredients such as water, during the preparation of the composition.

The PMC herein may be contained in a microcapsule slurry. In the context of the present invention, a microcapsule slurry is defined as a watery dispersion, preferably comprising from 10% to 50%, alternatively from 20% to 40%, by weight of the slurry, of the PMCs.

The microcapsule slurry herein can comprise a water-soluble salt. The term “water-soluble salt” herein means water-soluble ionic compounds, composed of dissociated positively charged cations and negatively charged anions. It is defined as the solubility in demineralised water at ambient temperature and atmospheric pressure. The microcapsule slurry may comprise from 1 mmol/kg to 750 mmol/kg, alternatively from 10 mmol/kg to 300 mmol/kg, of the water-soluble salt. In one embodiment, the water-soluble salt can be present as a residual impurity of the microcapsule slurry. This residual impurity can be from other ingredients in the microcapsule slurry, which are purchased from various suppliers. Alternatively, the water-soluble salt is intentionally added to the microcapsule slurry to adjust the rheology profile of the microcapsule slurry, thereby improving the stability of the slurry during transport and long-term storage.

Preferably, the water-soluble salt present in the microcapsule slurry is formed of polyvalent cations selected from alkaline earthmetals, transition metals or metals, together with suitable monoatomic or polyatomic anions. In one embodiment, the water-soluble salt comprises cations, the cations being selected from the group consisting of Beryllium, Magnesium, Calcium, Strontium, Barium, Scandium, Titan, Iron, Copper, Aluminium, Zinc, Germanium, and Tin, preferably are Magnesium. In one embodiment, the water-soluble salt comprises anions, the anions being selected from the group consisting of Fluorine, Chlorine, Bromine, Iodine, Acetate, Carbonate, Citrate, hydroxide, Nitrate, Phosphite, Phosphate and Sulfate, preferably the anions are the monoatomic anions of the halogens. Most preferably, the water-soluble salt is magnesium chloride, and the magnesium chloride is preferably present in the slurry from 0.1% to 5%, preferably 0.2% to 3%, by weight of the slurry.

In one embodiment, a process of making a microcapsule slurry comprises: combining, in any order, a PMC (without a polymer coating yet), an efficiency polymer, and optionally a stabilization system, and optionally a biocide. Preferably, the efficiency polymer comprises polyvinyl formamide, and the stabilization system comprises magnesium chloride and xanthan gum. In one embodiment, the PMC and the efficiency polymer are permitted to be in intimate contact for at least 15 minutes, preferably for at least 1 hour, more preferably for at 4 hours before the slurry is used in a product, thereby forming a polymer coating coating the PMC. Suitable PMCs that can be turned into the polymer-coated PMCs disclosed herein can be made in accordance with applicants' teaching, such as the teaching of US 2008/0305982 A1 and US 2009/0247449 A1. Alternatively, suitable polymer-coated capsules can be purchased from Appleton Papers Inc. of Appleton, Wis. USA.

### Adjunct Ingredients

The laundry detergent composition herein may comprise adjunct ingredients. Suitable adjunct ingredients include but are not limited to: anionic surfactants, nonionic surfactants, cationic surfactants, amphoteric surfactants, organic solvents, builders, chelating agents, rheology modifiers, dye transfer inhibiting agents, dispersants, enzymes, and enzyme stabilizers, catalytic materials, bleach activators, hydrogen peroxide, sources of hydrogen peroxide, preformed peracids, clay soil removal/anti-redeposition agents, brighteners, suds suppressors, dyes, photobleaches, neat perfume oils, structure elasticizing agents, fabric softeners, carriers, processing aids, hueing agents, structurants, and/or pigments. In addition to the disclosure below, suitable examples of such other adjuncts and levels of use are found in U.S. Pat. Nos. 5,576,282, 6,306,812 B1 and 6,326,348 B1 that are incorporated by reference. The precise nature of these adjunct ingredients and the levels thereof in the laundry detergent composition will depend on the physical form of the composition and the nature of the cleaning operation for which it is to be used.

In one embodiment, the laundry detergent composition herein further comprises a surfactant selected from the group consisting of anionic surfactant, nonionic surfactant, cationic surfactant, amphoteric surfactant, and a combination thereof. Preferably the composition comprises from 3% to 70%, preferably from 5% to 50%, more preferably from 10% to 40%, by weight of the composition, of an anionic surfactant, and from 1% to 20%, preferably from 2% to 18%, more preferably from 3% to 15%, by weight of the composition, of a nonionic surfactant.

In one embodiment, the composition comprises an anionic surfactant. Non-limiting examples of anionic surfactants include: linear alkylbenzene sulfonate (LAS), preferably C10-C16 LAS; C10-C20 primary, branched-chain and random alkyl sulfates (AS); C10-C18 secondary (2,3)alkyl sulfates; sulphated fatty alcohol ethoxylate (AES), preferably C10-C18 alkyl alkoxy sulfates (AExS) wherein preferably x is from 1-30, more preferably x is 1-3; C10-C18 alkyl alkoxy carboxylates preferably comprising 1-5 ethoxy units; mid-chain branched alkyl sulfates as discussed in U.S. Pat. No. 6,020,303 and U.S. Pat. No. 6,060,443; mid-chain branched alkyl alkoxy sulfates as discussed in U.S. Pat. No. 6,008,181 and U.S. Pat. No. 6,020,303; modified alkylbenzene sulfonate (MLAS) as discussed in WO 99/05243, WO 99/05242, and WO 99/05244; methyl ester sulfonate (MES); and alpha-olefin sulfonate (AOS). Preferably, the composition comprises an anionic surfactant selected from the group consisting of LAS, AES, AS, and a combination thereof, more preferably selected from the group consisting of LAS, AES, and a combination thereof. In one preferred embodiment, the composition comprises an anionic surfactant system comprising AES and LAS. The total level of the anionic surfactant(s) may be from 3% to 70%, preferably present from 5% to 50%, more preferably from 10% to 40%, by weight of the composition, in the composition, by weight of the liquid detergent composition. In the execution where both AES and LAS are present in the composition, the weight ratio of the AES to LAS is from 0.1:1 to 10:1, preferably from 0.2:1 to 5:1, more preferably from 0.4:1 to 1:1.

In one embodiment, the composition herein comprises a nonionic surfactant, preferably an alkoxylated nonionic surfactant. Non-limiting examples of alkoxylated nonionic surfactants suitable for use herein include: C12-C18 alkyl ethoxylates, such as Neodol® nonionic surfactants available from Shell; C6-C12 alkyl phenol alkoxylates wherein the alkoxylate units are a mixture of ethyleneoxy and propyleneoxy units; C12-C18 alcohol and C6-C12 alkyl phenol condensates with ethylene oxide/propylene oxide block alkyl polyamine ethoxylates such as Pluronic® available from BASF; C14-C22 mid-chain branched alkyl alkoxylates, BAEx, wherein x is from 1-30, as discussed in U.S. Pat. No. 6,153,577, U.S. Pat. No. 6,020,303 and U.S. Pat. No. 6,093,856; alkylpolysaccharides as discussed in U.S. Pat. No. 4,565,647 Llenado; specifically alkylpolyglycosides as discussed in U.S. Pat. No. 4,483,780 and U.S. Pat. No. 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408. Also useful herein as nonionic surfactants are alkoxylated ester surfactants such as those having the formula R1C(O)O(R20)nR3 wherein R1 is selected from linear and branched C6-C22 alkyl or alkylene moieties; R2 is selected from C2H4 and C3H6 moieties and R3 is selected from H, CH3, C2H5 and C3H7 moieties; and n has a value between 1 and 20. Such alkoxylated ester surfactants include the fatty methyl ester ethoxylates (MEE) and are well-known in the art; see for example U.S. Pat. No. 6,071,873; U.S. Pat. No. 6,319,887; U.S. Pat. No. 6,384,009; U.S. Pat. No. 5,753,606; WO 01/10391, WO 96/23049.

In one embodiment, the alkoxylated nonionic surfactant herein is C6-C22 alkoxylated alcohol, preferably C8-C18 alkoxylated alcohol, more preferably C12-C16 alkoxylated alcohol. The C6-C22 alkoxylated alcohol is preferably an alkyl alkoxylated alcohol with an average degree of alkoxylation of from 1 to 50, preferably 3 to 30, more preferably from 5 to 20, even more preferably from 5 to 9. The alkoxylation herein may be ethoxylation, propoxylation, or a mixture thereof, but preferably is ethoxylation. In one embodiment, the alkoxylated nonionic surfactant is C6-C22 ethoxylated alcohol, preferably C8-C18 alcohol ethoxylated with an average of 5 to 20 moles of ethylene oxides, more preferably C12-C16 alcohol ethoxylated with an average of 5 to 9 moles of ethylene oxides. One preferred example of the alkoxylated nonionic surfactant is C12-C15 alcohol ethoxylated with an average of 7 moles of ethylene oxide, e.g., Neodol®25-7 commercially available from Shell.

In one embodiment, the composition herein comprises a cationic surfactant. Non-limiting examples of cationic surfactants include: the quaternary ammonium surfactants, which can have up to 26 carbon atoms include: alkoxylate quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660, 4,260,529 and U.S. Pat. No. 6,022,844; and amino surfactants as discussed in U.S. Pat. No. 6,221,825 and WO 00/47708, specifically amido propyldimethyl amine (APA).

In one embodiment, the composition herein comprises an amphoteric surfactant. Non-limiting examples of amphoteric surfactants include: derivatives of secondary and tertiary amines, derivatives of heterocyclic secondary and tertiary amines, or derivatives of quaternary ammonium, quaternary phosphonium or tertiary sulfonium compounds. Preferred examples include: betaine, including alkyl dimethyl betaine and cocodimethyl amidopropyl betaine, C8 to C18 (or C12 to C18) amine oxides and sulfo and hydroxy betaines, such as N-alkyl-N,N-dimethylammino-1-propane sulfonate where the alkyl group can be C8 to C18, or C10 to C14.

Preferably, the amphoteric surfactant herein is selected from water-soluble amine oxide surfactants. A useful amine oxide surfactant is:

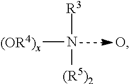

where R3 is a C8-22 alkyl, a C8-22 hydroxyalkyl, or a C8-22 alkyl phenyl group; each R4 is a C2-3 alkylene, or a C2-32 hydroxyalkylene group; x is from 0 to about 3; and each R5 is a C1-3 alkyl, a C1-3 hydroxyalkyl, or a polyethylene oxide containing from about 1 to about 3 EOs. Preferably, the amine oxide surfactant may be a C10-18 alkyl dimethyl amine oxide or a C8-12 alkoxy ethyl dihydroxy ethyl amine oxide.

In one embodiment, the composition herein further comprises a rheology modifier (also referred to as a “structurant” in certain situations), which functions to suspend and stabilize the microcapsules and to adjust the viscosity of the composition so as to be more applicable to the packaging assembly. The rheology modifier herein can be any known ingredient that is capable of suspending particles and/or adjusting rheology to a liquid composition, such as those disclosed in U.S. Patent Application Nos. 2006/0205631A1, 2005/0203213A1, and U.S. Pat. Nos. 7,294,611, 6,855,680. Preferably the rheology modifier is selected from the group consisting of hydroxy-containing crystalline material, polyacrylate, polysaccharide, polycarboxylate, alkali metal salt, alkaline earth metal salt, ammonium salt, alkanolammonium salt, C12-C20 fatty alcohol, di-benzylidene polyol acetal derivative (DBPA), di-amido gallant, a cationic polymer comprising a first structural unit derived from methacrylamide and a second structural unit derived from diallyl dimethyl ammonium chloride, and a combination thereof. Preferably, the rheology modifier is a hydroxy-containing crystalline material generally characterized as crystalline, hydroxyl-containing fatty acids, fatty esters and fatty waxes, such as castor oil and castor oil derivatives. More preferably the rheology modifier is a hydrogenated castor oil (HCO).

In one embodiment, the composition herein further comprises a neat perfume oil. Preferably, the neat perfume oil is present from 0.1% to 5%, preferably from 0.2% to 3%, more preferably from 0.3% to 2%, by weight of the composition, in the composition. Without wishing to be bound by theory, it is believed that since the nonionic anti-microbial agent and PMC deliver improved freshness, the composition of the present invention does not require a relatively high level of neat perfume oil. By contrast, the incorporation of a relatively high level of neat perfume oil is a typical approach in the art to provide freshness to treated fabrics.

In a highly preferred embodiment, the laundry detergent composition of the present invention comprises:

a) from 0.03% to 0.5%, by weight of the composition, of the anti-microbial agent, wherein the anti-microbial agent is 4-4′-dichloro-2-hydroxy diphenyl ether;

b) from 0.15% to 2%, by weight of the cleaning composition, of the PMC, wherein the shell comprises an outer surface and the PPMC comprises a coating coating the outer surface, wherein the shell comprises a melamine formaldehyde, and wherein the coating comprises an efficiency polymer of a polyvinyl formamide; and

c) from 0.05% to 1%, by weight of the composition, of a hydrogenated castor oil.

### Composition Preparation

The laundry detergent composition of the present invention is generally prepared by conventional methods such as those known in the art of making laundry detergent compositions. Such methods typically involve mixing the essential and optional ingredients in any desired order to a relatively uniform state, with or without heating, cooling, application of vacuum, and the like, thereby providing laundry detergent compositions containing ingredients in the requisite concentrations.

### Water-Soluble Pouch

One aspect of the present invention is directed to a pouch comprising the laundry detergent composition and a water-soluble film, wherein the composition is contained within the water-soluble film. The pouch herein is typically a closed structure, made of the water-soluble film enclosing an internal volume which comprises the laundry detergent composition. The pouch can be of any form and shape which are suitable to hold and protect the composition, e.g. without allowing the release of the composition from the pouch prior to contact of the pouch to water. The exact execution will depend on factors like the type and amount of the composition in the pouch, the number of compartments in the pouch, the characteristics required for the water-soluble film to hold, protect, and release the composition.

The water-soluble film of the pouch preferably comprises a polymer. The film can be obtained from methods known in the art, e.g., by casting, blow molding, extrusion molding, injection molding of the polymer. Non-limiting examples of the polymer for making the water-soluble film include: polyvinyl alcohols (PVAs), polyvinyl pyrrolidone, polyalkylene oxides, (modified) cellulose, (modified) cellulose-ethers or -esters or -amides, polycarboxylic acids and salts including polyacrylates, copolymers of maleic/acrylic acids, polyaminoacids or peptides, polyamides including polyacrylamide, polysaccharides including starch and gelatine, natural gums such as xanthum and carragum. Preferably, the water-soluble film comprises a polymer selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, hydroxypropyl methyl cellulose (HPMC), and a combination thereof. Most preferably, the water-soluble film comprises a polyvinyl alcohol, e.g., film M8630 or M9467 commercially available from MonoSol. Suitable polymers for making the water-soluble film of the pouch can be found in U.S. Pat. No. 6,995,126.

The pouch herein may comprise a single compartment or multiple compartments, preferably comprise multiple compartments, e.g., two compartments or three compartments. In the multi-compartment execution, the pouch comprises multiple films which form the multiple compartments, i.e., the inner volume of the multiple films is divided into the multiple compartments. Examples of these multi-compartment pouches are described in U.S. Pat. Nos. 4,973,416, 5,224,601, and 8,066,818.

In a multi-compartment execution, it is preferably that at least two of the multiple compartments have different solubility under the same condition, releasing the compositions which they partially or totally envelop at different times, e.g., at different time points during a wash cycle. The term “solubility” herein is not intended to refer to total solubility of a film but to the point at which the pouch in the wash solution breaks to release its content. Difference in solubility of each compartment can be achieved by means of films made of different polymers, films of different thickness, or films which solubility is temperature dependent, or by properties of the compartment (e.g., size, weight, relative position of the compartment). One example of the means of obtaining delayed release by pouches with different compartments, where the compartments are made of films having different solubility are taught in WO 02/08380. In one preferred embodiment, the required laundry detergent composition is contained in a compartment that dissolves later than other compartments of the pouch during a wash cycle. This enables longer time of the nonionic anti-microbial agent and PMC being hold in the compartment, and therefore less amounts of the compounds being washed away during the wash cycle.

In the multi-compartment execution, the required laundry detergent composition is contained in one or more compartments of the multiple compartments, preferably in one compartment of the multiple compartments. The multiple compartments of the pouch may comprise either the same composition or different compositions. The term “different compositions” herein refer to compositions that differ in at least one ingredient. In one embodiment, each of the multiple compartments comprises the same composition, which is the laundry detergent composition required by the present invention. Alternatively, at least two of the multiple compartments of the pouch comprise two different compositions. In a preferred embodiment, each of the multiple compartments has different colors, e.g., comprising different dyes that impart different colors to the multiple compositions contained in the multiple compartments, thus being more appealing to users.

In another preferred embodiment, the pouch comprises three compartments, wherein the three compartments comprise a first compartment, a second compartment, and a third compartment. Preferably, the first compartment and the second compartment are placed side-by-side and superposed (i.e., placed above) onto the third compartment, wherein the required laundry detergent composition is preferably contained in the third compartment. When the required laundry detergent composition, preferably in a liquid form, is contained in the third compartment, the first compartment and the second compartment may comprise either a liquid or solid composition. For example, the third compartment comprises the required laundry detergent composition, the first compartment comprises a first composition in a liquid form, and the second compartment comprises a second composition in a liquid form, wherein the first composition and the second composition are either the same or different. An alternative example is that, the third compartment comprises the required laundry detergent composition, the first compartment comprises a first composition in a liquid form, and the third compartment comprises a third composition in a solid form.

The pouch may be of such a size that it conveniently contains either a unit dose amount of the composition herein, suitable for the required operation, for example one wash, or only a partial dose, to allow a user greater flexibility to vary the amount used, e.g., depending on the size or degree of soiling of the wash load. In one embodiment, the pouch has an internal volume of from about 10 ml to about 50 ml, preferably from about 12 ml to about 30 ml, more preferably from about 15 to about 25 ml. In particular, more suitable pouches have a square or rectangular base and a height of from about 1 cm to about 5 cm, preferably from about 1 cm to about 4 cm. In terms of weight, the pouch preferably has a weight of from about 5 grams to about 50 grams, more preferably from about 10 grams to about 40 grams, even more preferably from about 15 grams to about 30 grams.

The pouch of the present invention can be made by any suitable processes known in the art. Example processes of making the pouch can be found in U.S. Pat. Nos. 6,995,126, 7,127,874, 8,156,713, 7,386,971, 7,439,215, and US Patent Publication No. 2009/199877. For example, the multi-compartment pouch herein is obtainable by the process of closing an open compartment with a pre-sealed compartment, wherein the process forms a second seal on the pre-sealed compartment which is in a different position to the first seal of the pre-sealed compartment, as disclosed in U.S. Pat. No. 6,995,126. Alternatively, the multi-compartment pouch could be obtainable by the steps of: a) making a first compartment in a first pouch making unit having a first forming surface, wherein the first compartment is made by placing a water-soluble film on the surface of the first pouch making unit, the surface has moulds into which the water-soluble film is drawn to form an open compartment, the open compartment is then filled with a detergent composition, and preferably the resulting compartment is subsequently closed; b) making a second compartment in a second pouch making unit having a second forming surface, wherein the second compartment is made in a similar manner to the first compartment and preferably is subsequently closed; c) combining the first and second compartment wherein the first and second forming surfaces bring the first and second compartments into contact and exert pressure on them to seal the first and second compartments to form a pouch; and d) cutting the resulting pouches to produce individual pouches having multiple compartments, as disclosed in US Patent Publication No. 2009/199877.

### Method of Use

Another aspect of the present invention is directed to a method of using the laundry detergent composition to treat a fabric, with an anti-microbial benefit. The method comprises the step of administering from 5 g to 120 g of the aforementioned laundry detergent composition into a washing basin comprising water to form a washing solution. The washing solution in a laundry washing basin herein preferably has a volume from 1 L to 50 L, alternatively from 1 L to 20 L for hand washing and from 20 L to 50 L for machine washing. Preferably, the anti-microbial benefit herein is determined by the JISL 1902 method. The temperature of the washing solution preferably ranges from 5° C. to 60° C., more preferably from 20° C. to 50° C.

The dosing amount in the method herein may be different depending on the washing type. In one embodiment, the method comprises administering from 5 g to 60 g of the laundry detergent composition into a hand washing basin (e.g., 4 L). In an alternative embodiment, the method comprises administering from 60 g to 120 g of the laundry detergent composition into a washing machine (e.g., 30 L). In the water-soluble pouch execution, the method comprises administering a pouch into a washing basin.

Preferably, the method herein further comprises the step of contacting a fabric with the washing solution, wherein the fabric is in need of an anti-microbial treatment. For example, the presence of gram positive bacteria and/or gram negative bacteria is suspected on the fabric. The step of contacting the fabric with the washing solution is preferably after the step of administering the laundry detergent composition in a washing basin. The method may further comprise the step of contacting a fabric with the laundry detergent composition prior to the step of administering the laundry detergent composition in a washing basin, i.e., pre-treat the fabric with the laundry detergent composition for certain time preferably for 1 minute to 10 minutes.

### Test Method

Method for Determining of Freshness Performance for Detergent Compositions

The freshness performance of detergent compositions is characterized by Olfactory Grading Data for malodor intensity and freshness intensity, as described below.

1. Sample Preparation

A. A 100% Cotton terry towel (obtained from Shindo Shikifu, Osaka, Japan) is used as the test fabric. Cut the test fabric to two pieces, each having a size of 30 cm*10 cm.
B. One piece of fabric is washed with a test sample (or test pouch, i.e., the composition or pouch according to the present invention), and the other piece of fabric is washed with a control sample (or control pouch, i.e., the comparative composition or pouch), separately. For washing condition, the test fabric and sample (or pouch) are placed in a validated Japan Top Load Washing Machine (NA-FV8000) and washed for 12 minutes with 49 liters of water (around 3 gpg) at 20° C. One batch rinse, spin dry at 3 min, and line dry completely in drying room. The fabric load is 2.7 kg (test fabric and Ballast T-shirt).
C. Sew the two pieces of fabric (washed with the test sample and control sample, respectively) to form a towel.
D. A panelist uses the towel as a kitchen towel for two days.
E. Collect the used towel from the user and incubate at 23° C. overnight.
F. Unsew and divide the towel to the original two pieces of fabric again.
G. Wash each piece of fabric again, with the sample (or pouch) by which the piece of fabric has been washed and under the same washing condition as in above step B.
H. Each washed piece of fabric is put in a closed bag and kept at 23° C. overnight.

2. Olfactory Grading for Malodor and Freshness Intensity

Right after step 1H when the fabrics are still wet, the panelist who has used the fabrics as a kitchen towel is asked to evaluate his/her own used fabrics as Indoor Dry simulation. Then air dry the fabrics and re-wet the fabrics by spraying water. Then the panelist is asked to evaluate the two pieces of wet fabric with manual rubbing as In Use simulation. 10 replicates are conducted (i.e., 10 panelists participated) for each test.

During the evaluation, the two pieces of fabric (washed with the test sample and control sample, respectively) are compared by the panelist. The grading scale is 0-4, with 0 representing no difference and 4 representing a large difference. Both freshness intensity (perfume intensity) and malodor intensity (unpleasant smell intensity) between the two pieces of fabric are evaluated. The results are statistically analyzed by T-test, and a statistical difference with 90% confidence level by T-test is reported as -s-.

Method for Determining of Anti-Microbial Efficacy for Detergent Compositions

The anti-microbial efficacy for laundry detergent compositions is determined by the method as defined in the JISL 1902 method and described hereinafter.

1. Microorganism Preparation

A. Aseptically add certain amount of nutrient broth into a lyophilized culture of Staphylococcus aureus or Klebsiella pneumoniae. Dissolve and suspend the culture in the nutrient broth to obtain a suspension. Streak a loop of the suspension onto a nutrient agar plate, and incubate at 37° C. for 24 hours to obtain a first generation subculture of bacterial suspension. Transfer a loop of the first generation subculture of bacterial suspension into 20 mL of nutrient broth with shaking, and incubate at 37° C. for 24 hours to obtain a second generation subculture of bacterial suspension. Transfer 0.4 mL of the second generation subculture of bacterial suspension into another 20 mL of nutrient broth with shaking, and incubate at 37° C. for 3 hours to obtain a third generation subculture of bacterial suspension.
B. Dilute the third generation subculture of bacterial suspension by 1/20 diluted nutrient broth to 1×105 cells/mL to obtain a working culture.
C. Store the working culture at 4° C. The working culture cannot be stored overnight.

2. Fabric Washing

A. Boil two fabric strips each having a width of 5 cm and length of 2.5 m (32 yarn/cm×32 yarn/cm, 100% plain weave cotton) in 3 L of a solution for 1 hour. The solution is prepared by 1.5 g of a nonionic soaked agent, 1.5 g of sodium carbonate, and 3000 mL of distilled water. The nonionic soaked agent is prepared by 5.0 g of alkylphenol ethoxylate, 5 g of sodium carbonate, and 1000 mL of distilled water. Rinse the fabric strips in boiled deionized water for 5 minutes. Place the fabric strips in cool deionized water for 5 minutes, and indoor dry. One fabric strip serves as a test fabric strip for following steps 2B -2I, and the other fabric strip is used as control (without experiencing steps 2B -2I).
B. Fix one end of the test fabric strip obtained from step 2A onto a stainless steel spindle at an outer position along the horizontal extension of the stainless steel spindle. The stainless steel spindle has 3 horizontal stands that are connected to one another. Wrap the test fabric strip around the 3 horizontal stands of the stainless steel spindle with sufficient tension to obtain a fabric wrapped spindle having 12 laps of fabric. Fix the other end of the test fabric strip onto the outer lap of the 12 laps of fabric via a pin. Sterilize the fabric wrapped spindle with pressure steam at 121° C. for 15 minutes.
C. Dissolve 5.903 g of calcium chloride dihydrate and 2.721 g of magnesium chloride hexahydrate in 100 mL of distilled water, and then sterilize the mixture with pressure steam at 121° C. for 20 minutes. Add 1 mL of the mixture into 1 L of distilled water to obtain a hard water solution.
D. Add sufficient amount of sample into 1 L of the hard water solution obtained from step 2C to obtain a solution having a concentration of 2069 ppm. Mix the solution by a magnetic stirrer for 4 minutes. Distribute 250 mL of the mixed solution into an exposure chamber to obtain a washing solution. Place the exposure chamber in a water bath and achieve the test temperature of (25±1°) C. The exposure chamber is then sterilized with pressure steam at 121° C. for 15 minutes.
E. Aseptically soak the fabric wrapped spindle obtained from step 2B into the washing solution in the exposure chamber, and close the exposure chamber with a lid.
F. Fix the exposure chamber onto a tumbler. Rotate the tumbler for 10 minutes. Then remove the fabric wrapped spindle from the exposure chamber. Place the fabric wrapped spindle in Haier iwash-1p Top Load Washing Machine and rinse for 2 minutes.
G. Discard the washing solution from the exposure chamber, and then add 250 mL of sterilized distilled water into the exposure chamber. Soak the rinsed fabric wrapped spindle in the newly added distilled water in the exposure chamber. Rotate the tumbler for 3 minutes.
H. Repeat step 2G.
I. Aseptically remove the fabric wrapped spindle out of the exposure chamber and remove the test fabric strip from the spindle. Air dry the test fabric strip overnight.

3. Fabric Incubation

A. Cut the washed test fabric strip obtained from step 2I to square pieces having a side length of 2 cm. 3 sets of 0.4 g of the pieces serve as specimens for the following steps.
B. Put each set of specimens into a vial, and then sterilize the specimens with pressure steam at 121° C. for 15 minutes. After the sterilization, dry the specimens for 1 hour in a clean bench without a cap.
C. Inoculate 0.2 mL of the working culture obtained from step 1C onto each dried specimen.

Incubate the vials containing the inoculated specimens at 37° C. for 18 hours.

D. Extract survivors on the incubated specimens, plate with nutrient agar, and incubate at 37° C. for 24-48 hours. Count the total colony-forming units (CFU) of each set of specimens, and obtain average results of the 3 sets. Take the log 10 value of CFU value as Mb.
E. In steps 3A-3D, use the fabric strip obtained from step 2A (that does not experience steps 2B-2I) as control. Take the log 10 value of CFU value as Ma.

4. Calculation of Bacteriostatic Activity Value

Bacteriostatic Activity Value=Mb−Ma

A Bacteriostatic Activity Value of greater than 2.2 represents good anti-microbial efficacy. And a Bacteriostatic Activity Value of lower then 2.2 indicates unacceptable poor anti-microbial efficacy.

Method for Determining of Average Molecular Mass

The average molecular mass of a polymer is determined in accordance with ASTM Method D4001-93(2006).

Method for Determining of Hydrolysis Degree

The hydrolysis degree is determined in accordance with the method found in U.S. Pat. No. 6,132,558, column 2, line 36 to column 5, line 25.

Method for Determining of Charge Density

The charge density of a polymer is determined with the aid of colloid titration, cf. D. Horn, Progress in Colloid & Polymer Sci. 65 (1978), 251-264.

### EXAMPLE

The Examples herein are meant to exemplify the present invention but are not used to limit or otherwise define the scope of the present invention. Examples 1A-1B, 2A-2C, and 3 are examples according to the present inventions, and Example 4 is comparative example.

### Example 1A

### 84 wt % Core/16 wt % Wall Melamine Formaldehyde Perfume Microcapsule

25 grams of butyl acrylate-acrylic acid copolymer emulsifier (Colloid C351, 25% solids, pka 4.5-4.7, (Kemira Chemicals, Inc. Kennesaw, Ga. U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, (Cytec Industries West Paterson, N.J., U.S.A.)) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Mo., U.S.A.) is added to the suspension. An average capsule size of 30 um is obtained as analyzed by a Model 780 Accusizer.

### Example 1B

### Polymer-Coated Perfume Microcapsule

Polymer-coated perfume microcapsules are prepared by weighing 99 g of melamine formaldehyde perfume microcapsules slurry obtained from Example 1A and 1 g of polyvinyl formamide (16% active, commercially available from BASF AG of Ludwigshafen, Germany, under the name of Lupamin® 9030) in a glass jar. The ingredients are shortly mixed with a spoon and are further mixed overnight in a shaker. Thus, a polymer-coated perfume microcapsule is obtained.

### Example 2

### Formulations of Liquid Laundry Detergent Compositions

The following liquid laundry detergent compositions shown in Table 1 are made comprising the listed ingredients in the listed proportions (weight %).

TABLE 1

| | 2A | 2B | 2C |
|---|---|---|---|
| C₁₂-₁₄AE₁₋₃S | 13 | 8.3 | 10 |
| C₁₁-₁₃LAS | 3 | 5.5 | 6.5 |
| Neodol ®25-7 a | 1.4 | 4 | 7 |
| Citric acid | 0 | 2 | 1.7 |
| Boric acid | 0 | 2 | 1.9 |
| C₁₂-C₁₈ fatty acid | 1.5 | 1.2 | 1.3 |
| Na-DTPA b | 0.06 | 0.2 | 0.4 |
| Propylene glycol | 0 | 1.2 | 2.5 |
| Calcium chloride | 0 | 0 | 0.06 |
| Silicone emulsion | 0 | 0.0025 | 0.0025 |
| Monoethanolamine | 0.096 | 0.096 | 0.096 |
| NaOH | Up to pH 8 | Up to pH 8 | Up to pH 8 |
| Tinosan ®HP100 c | 0.25 | 0.25 | 0.25 |
| Perfume microcapsule of | 0.15 | 0.15 | 0.35 |
| Example 1B | | | |
| Hydrogenated castor oil | 0.12 | 0.12 | 0.12 |
| Brightener | 0 | 0.06 | 0.06 |
| Protease | 0 | 0 | 0.45 |
| Amylase | 0 | 0 | 0.08 |
| Dye | 0 | 0.002 | 0.002 |
| Neat perfume oil | 0 | 0.6 | 0.6 |
| Water | Add to 100 | Add to 100 | Add to 100 |

a Neodol ®25-7 is C₁₂-C₁₅ alcohol ethoxylated with an average of 7 moles of ethylene oxide as a nonionic surfactant, available from Shell
b penta sodium salt diethylene triamine penta acetic acid as a chelant
c Tinosan ®HP100 is 4-4′-dichloro-2-hydroxy diphenyl ether, available from BASF

### Preparation of the Compositions of Examples 2A-2C

The liquid laundry detergent compositions of Examples 2A-2C are prepared by the following steps:

a) mixing a combination of NaOH and water in a batch container by applying a shear of 200 rpm;
b) adding citric acid (if any), boric acid (if any), C11-C13 LAS, and NaOH into the batch container, keeping on mixing by applying a shear of 200 rpm;
c) cooling down the temperature of the combination obtained in step b) to 25° C.;
d) adding C12-14AE1-3S, Na-DTPA, Neodol®25-7, C12-C18 fatty acid, propylene glycol (if any), calcium chloride (if any), silicone emulsion (if any), and Tinosan®HP100 into the batch container, mixing by applying a shear of 250 rpm until the combination is homogeneously mixed, and adjusting pH to 8;
e) adding brightener, protease, amylase, dye, and neat perfume oil into the batch container, mixing by applying a shear of 250 rpm;
f) adding perfume microcapsule obtained in Example 1B, and mixing by applying a shear of 250 rpm for 1 minute; and
g) adding monoethanolamine and hydrogenated castor oil into the batch container, thus forming a liquid laundry detergent composition,

wherein each ingredient in the composition is present in the level as specified for Examples 2A-2C in Table 1.

### Examples 3 and 4

### One-Compartment Pouches Comprising a Liquid Laundry Detergent Composition

The composition as shown in Table 2 is each introduced into a pouch having one compartment and is made comprising the listed ingredients in the listed proportions (weight %). The pouches of Example 3 and Comparative Example 4 have the same compositional weight of 25.3 grams. The film used is MonoSol M9467 film with a thickness of 76 μm as supplied by MonoSol.

TABLE 2

| | 3 | Comparative 4 |
|---|---|---|
| C₁₁-C₁₃LAS | 14.5 | 14.5 |
| C₁₂-C₁₄AE₁₋₃S | 11.1 | 11.1 |
| Neodol ®25-7 a | 11.8 | 11.8 |
| Citric acid | 1.2 | 1.2 |
| C₁₂-C₁₈ fatty acid | 12.5 | 12.5 |
| HEDP b | 2.0 | 2.0 |
| Propylene glycol | 15.9 | 15.9 |
| Glycerol | 6.1 | 6.1 |
| Polyethyleneimine ethoxylate c | 5.0 | 5.0 |
| Potassium sulfite | 0.5 | 0.5 |
| Monoethanolamine | 7.5 | 7.5 |
| Magnesium chloride | 0.7 | 0.7 |
| Brightener | 2.5 | 2.5 |
| Protease | 1.1 | 1.1 |
| Amylase | 0.18 | 0.18 |
| Tinosan ®HP100 d | 0.25 | 0 |
| Perfume microcapsule of Example 1B | 1.15 | 1.15 |
| Hydrogenated castor oil | 0.13 | 0.13 |
| Dye | 0.3 | 0.3 |
| Neat perfume oil | 1.4 | 1.4 |
| Water | Add to 100 | Add to 100 |

a Neodol ®25-7 is C₁₂-C₁₅ alcohol ethoxylated with an average of 7 moles of ethylene oxide as a nonionic surfactant, available from Shell
b 1-hydroxyethane-1,1′-diphosphonic acid as a chelant
c Polyethyleneimine ethoxylate having a PEI backbone of MWₙ of about 600 and side chains of (EO)₂₀
d Tinosan ®HP100 is 4-4′-dichloro-2-hydroxy diphenyl ether, available from BASF

### Preparation of the Pouches of Examples 3 and 4

The pouches of Examples 3 and 4 are prepared by the following steps: 1. Composition Preparation

a) Mixing a combination of HEDP, propylene glycol, and water in a mixer by applying a shear of 200 rpm, and keeping the temperature of the combination under 45° C.;
b) adding monoethanolamine, Neodol®25-7, glycerol, potassium sulfite, C11-C13 LAS, citric acid, C12-C18 fatty acid, C12-C14AE1-3S, and Tinosan®HP100 (if any) in sequence into the combination obtained in step a), keeping on mixing by applying a shear of 200 rpm, adjusting pH with monoethanolamine to 7.4;
c) adding polyethyleneimine ethoxylate, magnesium chloride, brightener, protease, amylase, dye, and neat perfume oil into the combination obtained in step b),
d) adding perfume microcapsule obtained in Example 1B, and mixing by applying a shear of 250 rpm for 1 minute; and
e) adding monoethanolamine and hydrogenated castor oil, thus forming a liquid laundry detergent composition that will be later contained in a water-soluble film,

wherein in the composition, each ingredient is present in the amount as specified for Examples 3 and 4 in Table 2.

2. Pouch Manufacturing

a) A first piece of MonoSol M9467 film is placed on top of a small mould and fixed in place. The small mould consists of a hemispherical shape and has a diameter of 33 mm and a depth of 14.5 mm A 1 mm thick layer of rubber is present around the edges of the mould. The mould has some holes in the mould material to allow a vacuum to be applied to pull the film into the mould and pull the film flush with the inner surface of the mould. The liquid laundry detergent composition obtained from above step 1e) is poured into the mould;
b) A second piece of MonoSol M9467 film is placed over the top of the small mould with the liquid laundry detergent composition and sealed to the first piece of film by applying a metal ring having an inner diameter of 34 mm and heating that metal under moderate pressure onto the ring of rubber at the edge of the mould to heat-seal the two pieces of film together to form a sealed compartment comprising the liquid laundry detergent. The metal ring is typically heated to a temperature of from 135° C. to 150° C. and applied for up to 5 seconds. The sealed compartment has a 75 mm rim of the film which extends in an outwardly direction from the seal away from the centre of the pre-sealed compartment so that the sealed compartment can be fixed into place and completely cover the opening of a mould with a larger diameter of 48.5 mm A one-compartment pouch comprising a liquid laundry detergent composition is thereby formed.

Comparative Data on Freshness Performance

Comparative experiments of measuring the freshness performance of the pouches of Example 3 and Comparative Example 4 are conducted, according to the test method for freshness performance as described hereinabove. Specifically, the fabric treated by Example 3 is paired with that treated by Comparative Example 4 in terms of freshness intensity and malodor intensity. The experimental results, including both Indoor Dry and In Use simulation results, are shown in Table 3.

TABLE 3

| | Freshness Intensity | Malodor Intensity |
|---|---|---|
| Indoor Dry | 1.1 -s- | −1.1 -s- |
| In Use | 0.8 -s- | −0.9 -s- |

As shown in Table 2, the pouch comprising the laundry detergent composition according to the present invention (Example 3) demonstrates improved freshness performance, specifically increased freshness intensity and decreased malodor intensity, towards treated fabrics, in view of the pouch comprising the comparative composition (Comparative Example 4).

Unless otherwise indicated, all percentages, ratios, and proportions are calculated based on weight of the total composition. All temperatures are in degrees Celsius (° C.) unless otherwise indicated. All measurements made are at 25° C., unless otherwise designated. All component or composition levels are in reference to the active level of that component or composition, and are exclusive of impurities, for example, residual solvents or by-products, which may be present in commercially available sources.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising:
a) from about 0.001% to about 3%, by weight of the composition, of a nonionic anti-microbial agent; and
b) from about 0.05% to about 5%, by weight of the composition, of a perfume microcapsule (PMC), wherein said PMC comprises a shell and a core of perfume oil encapsulated within said shell.

2. The composition according to claim 1, wherein said nonionic anti-microbial agent is a diphenyl ether, preferably is a hydroxyl diphenyl ether compound of formula (I): 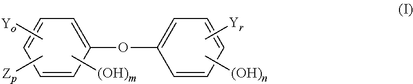
wherein:
each Y is independently selected from chlorine, bromine, or fluorine,
each Z is independently selected from SO₂H, NO₂, or C₁-C₄ alkyl,
r is 0, 1, 2, or 3,
o is 0, 1, 2, or 3,
p is 0, 1, or 2,
m is 1 or 2, and
n is 0 or 1.

3. The composition according to claim 2, wherein said nonionic anti-microbial agent is selected from the group consisting of 4-4′-dichloro-2-hydroxy diphenyl ether, 2,4,4′-trichloro-2′-hydroxy diphenyl ether, and a combination thereof, preferably said nonionic anti-microbial agent is 4-4′-dichloro-2-hydroxy diphenyl ether.

4. The composition according to claim 1, wherein said shell comprises an aminoplast, preferably comprises a melamine formaldehyde.

5. The composition according to claim 1, wherein said shell comprises an outer surface and a coating coating said outer surface, wherein said coating comprises an efficiency polymer of formula (II): 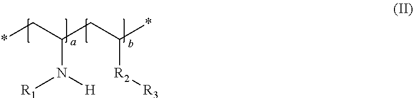
wherein:
d) a and b each independently range from about 50 to about 100,000;
e) each R¹ is independently selected from H, CH₃, (C═O)H, alkylene, alkylene with unsaturated C—C bonds, CH₂—CROH, (C═O)—NH—R, (C═O)—(CH₂)ₙ—OH, (C═O)—R, (CH₂)ₙ-E, —(CH₂—CH(C═O))ₙ—R, —(CH₂)ₙ—COOH, —(CH₂)ₙ—NH₂, or —CH₂)ₙ—(C═O)NH₂, the index n ranges from 0 to 24, E is an electrophilic group, R is a saturated or unsaturated alkane, dialkylsiloxy, dialkyloxy, aryl, or alkylated aryl, further containing a moiety selected from the group consisting of cyano, OH, COOH, NH₂, NHR, sulfonate, sulphate, —NH₂, quaternized amine, thiol, aldehyde, alkoxy, pyrrolidone, pyridine, imidazol, imidazolinium halide, guanidine, phosphate, monosaccharide, oligo, polysaccharide, and a combination thereof;
f) R² or R³ is absent or present:
(i) when R³ is present each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and each R³ is independently selected the same group as R¹;
(ii) when R³ is absent each R² is independently selected from —NH₂, —COO—, —(C═O)—, —O—, —S—, —NH—(C═O)—, —NR₁—, dialkylsiloxy, dialkyloxy, phenylene, naphthalene, or alkyleneoxy; and
(iii) when R² is absent, each R³ is independently selected the same group as R¹; and
wherein said efficiency polymer has: an average molecular mass from about 1,000 Da to about 50,000,000 Da; a hydrolysis degree of from about 5% to about 95%; and/or a charge density from about 1 meq/g to about 23 meq/g.

6. The composition according to claim 5, wherein said efficiency polymer is selected from the group consisting of polyvinyl amine, polyvinyl formamide, polyallyl amine, and copolymers thereof.

7. The composition according to claim 1, further comprising a rheology modifier selected from the group consisting of hydroxy-containing crystalline material, polyacrylate, polysaccharide, polycarboxylate, alkali metal salt, alkaline earth metal salt, ammonium salt, alkanolammonium salt, C₁₂-C₂₀ fatty alcohol, di-benzylidene polyol acetal derivative, di-amido gallant, a cationic polymer comprising a first structural unit derived from methacrylamide and a second structural unit derived from diallyl dimethyl ammonium chloride, and a combination thereof.

8. The composition according to claim 1, further comprising from about 3% to about 70%, by weight of the composition, of an anionic surfactant, and from about 1% to about 20%, by weight of the composition, of a nonionic surfactant.

9. The composition according to claim 1, further comprising from about 0.1% to about 5%, by weight of the composition, of a neat perfume oil.

10. The composition according to claim 1, comprising:
a) from about 0.03% to about 0.5%, by weight of the composition, of said nonionic anti-microbial agent, wherein said nonionic anti-microbial agent is 4-4′-dichloro-2-hydroxy diphenyl ether;
b) from about 0.15% to about 2%, by weight of the composition, of said PMC, wherein said shell comprises an outer surface and said PMC comprises a coating coating said outer surface, wherein said shell comprises a melamine formaldehyde, and wherein said coating comprises an efficiency polymer of a polyvinyl formamide; and
c) from about 0.05% to about 1%, by weight of the composition, of a hydrogenated castor oil.

11. A pouch, comprising a water-soluble film and the laundry detergent composition according to claim 1, within said water-soluble film.

12. The pouch according to claim 11, wherein said water-soluble film comprises a polyvinyl alcohol.
